(19) United States
(12) Patent Application Publication
(10) Pub. No.: US 2011/0311404 A1
(43) Pub. Date: Dec. 22, 2011

(54) Thermally Stable Inorganic Fibers For Exhaust Gas Treatment Device Insulating Mat

(76) Inventors: Matthew J. Creedon, Buffalo, NY (US); Amit Kumar, Getzville, NY (US)

(21) Appl. No.: 13/161,843

(22) Filed: Jun. 16, 2011

Related U.S. Application Data
(60) Provisional application No. 61/355,211, filed on Jun. 16, 2010.

(51) Int. Cl. B01D 53/94; B05D 3/10; B32B 5/16

(52) U.S. Cl. 422/177; 428/221; 427/226

(57) ABSTRACT

An insulating mat for an exhaust gas treatment device thermally stable to at least 900° C., wherein the insulating mat contains inorganic fibers uniformly coated with a metal oxide including at least one of aluminum oxide, titanium oxide, zirconium oxide, or mixtures thereof; wherein said fibers are uniformly coated with the metal oxide by precipitating metal hydroxide corresponding to the metal oxide on the fibers, followed by converting the precipitated metal hydroxide to the metal oxide. A method of increasing the thermal stability of inorganic fibers for use in an exhaust gas treatment device insulating mat including the inorganic fibers, including uniformly coating the fibers with a metal oxide of at least one of aluminum oxide, titanium oxide, zirconium oxide or mixtures thereof by a chemical precipitation process.

This application claims the benefit of the filing date of U.S. Provisional Application for Patent Ser. No. 61/355,211, filed Jun. 16, 2010, pursuant to 35 U.S.C. §119(e), which application is incorporated herein by reference.

A thermally stable insulating mat is provided for use in an exhaust gas treatment device, such as a catalytic converter and diesel particulate traps that are used in automotive exhaust systems. The mat may be used as a mounting mat to mount a fragile monolith within an outer housing of an exhaust gas treatment device or as thermal insulation in an end cone of the exhaust gas treatment device. A method is also provided for increasing the thermal stability of inorganic fiber for use in an insulating mat for the exhaust gas treatment device.

Exhaust gas treatment devices are used on automobiles to reduce atmospheric pollution from engine emissions. Examples of widely used exhaust gas treatment devices include catalytic converters and diesel particulate traps.

A catalytic converter for treating exhaust gases of an automotive engine includes a housing, a fragile catalyst support structure for holding the catalyst that is used to effect the oxidation of carbon monoxide and hydrocarbons and the reduction of oxides of nitrogen, and an insulating mounting mat disposed between the outer surface of the fragile catalyst support structure and the inner surface of the housing to resiliently hold the fragile catalyst support structure within the housing.

A diesel particulate trap for controlling pollution generated by diesel engines generally includes a housing, a fragile particulate filter or trap for collecting particulate from the diesel engine emissions, and a mounting mat that is disposed between the outer surface of the filter or trap and the inner surface of the housing to resiliently hold the fragile filter or trap structure within the housing.

The fragile catalyst support structure generally comprises a monolithic structure manufactured from a frangible material of metal or a brittle, ceramic material such as aluminum oxide, silicon dioxide, magnesium oxide, zirconia, cordierite, silicon carbide and the like. These materials provide a skeleton type of structure with a plurality of gas flow channels. These monolithic structures can be so fragile that even small shock loads or stresses are often sufficient to crack or crush them. In order to protect the fragile structure from thermal and mechanical shock and other stresses noted above, as well as to provide thermal insulation and a gas seal, a mounting mat is positioned within the gap between the fragile structure and the housing.

The mounting mat materials employed should be capable of satisfying any of a number of design or physical requirements set forth by the fragile structure manufacturers or the exhaust gas treatment device manufacturers. For example, the mounting mat material should be capable of exerting an effective residual holding pressure on the fragile structure, even when the exhaust gas treatment device has undergone wide temperature fluctuations, which causes significant expansion and contraction of the metal housing in relation to the fragile structure, which in turn causes significant compression and release cycles for the mounting mats over a period of time.

Ceramic and metallic substrates used in exhaust gas treatment devices are most often mounted within a metal housing with an inorganic fiber based mounting mat. This mounting mat material may contain only inorganic fiber. However, the mounting mat material may also contain other types of fiber, organic binder, inorganic binder and intumescent material.

The mounting mat must function across a wide range of operating temperatures to effectively hold the substrate in position. Substrates are subjected to axial forces acting on the substrate due to vibrations. The mounting mat also compensates for the fact that the metal housing expands more or less than the substrate itself. Various exhaust gas treatment devices operate throughout a temperature range of ambient conditions, such as 20° C., to about 1200° C. Therefore, mounting mats must provide robust holding pressure performance across this wide temperature range.

Inorganic fibers have been coated with various compounds such as oxides to enhance thermal stability or to provide an interfacial material for a composite reinforcement application. One known method comprises the application of oxides as powders or slurries followed by drying; however, such method does not result in application of a uniform layer of metal oxide. In another method, silica fibers are coated with a colloidal alumina powder by adding the powder to the wet end of the mat making process. This results in attachment of some of the alumina particles to the surfaces of the fibers. Improvement in mat performance may be achieved by increasing the friction between fibers due to the alumina particles.

While many mounting mats used in the industry today provide acceptable insulating properties, the industry constantly demands mounting mats which provide greater insulating properties without necessitating larger housings or increased overall mass. What is needed in the industry is a flexible insulating mat for exhaust gas treatment devices which can be easily installed and which can function across a wide range of inlet gas temperatures without a significant loss in mat thickness and corresponding holding pressure performance, while providing a superior thermal stability, allowing the mat to be used for higher temperature applications.

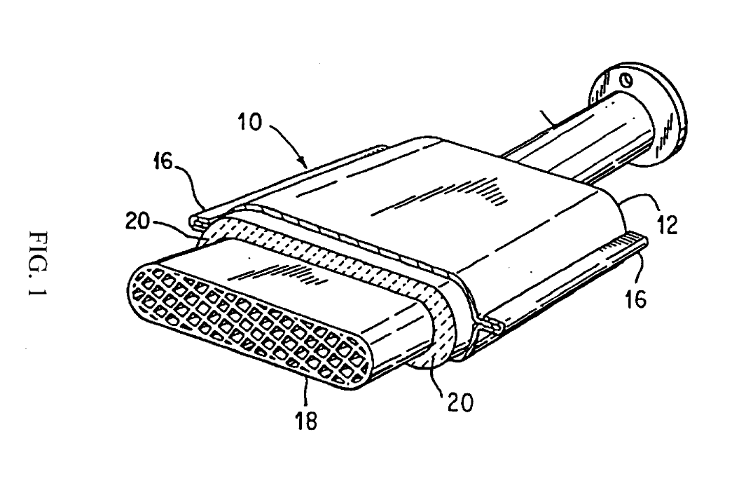

FIG. 1 shows a fragmentary view of an illustrative exhaust gas treatment device including a subject mounting mat.

A method of increasing the thermal stability of inorganic fibers for use in an exhaust gas treatment device insulating mat including the inorganic fibers is provided, comprising uniformly coating the fibers with a metal oxide comprising at least one of aluminum oxide, titanium oxide, zirconium oxide or mixtures thereof by a chemical precipitation process comprising: contacting the fibers with an aqueous solution of at least one water soluble corresponding metal salt of the metal oxide; while the fibers are in contact with the solution, precipitating a coating of a corresponding metal hydroxide from solution onto the fibers, optionally by increasing the solution pH to at least about 5 but less than about 7; and, (c) calcining the coated fibers at a temperature of at least about 300° C. for a time sufficient to convert the precipitated metal hydroxide to the metal oxide. In certain embodiments, the concentration of the metal salt in the aqueous solution may be in the range of about 0.01 to about 10 Molar.

According to certain illustrative embodiments, the method comprises after said precipitating, draining the solution to remove liquid from the fibers. According to certain embodiments, the method may comprise after said draining, drying the fibers at a temperature of from about 60° C. to about 150° C. until substantially dry, such as having less than about 1% free water by weight. According to certain illustrative embodiments, the method may further comprise mixing the fibers and the aqueous solution, such as for about 30 minutes, before increasing the solution pH, that is, for a sufficient amount of time to contact the surface of the fibers with the solution. The duration of mixing may be determined, considering the volume of the solution and fiber material, and the concentration of the metal salt. According to certain embodiments, the method may comprise applying multiple coatings of metal oxide to the fibers.

Further provided is a method of improving the thermal stability of an exhaust gas treatment device insulating mat containing inorganic fibers, comprising incorporating into the mat said inorganic fibers, uniformly coated with a metal oxide comprising at least one of aluminum oxide, titanium oxide, zirconium oxide or mixtures thereof by a chemical precipitation process, comprising precipitating metal hydroxide corresponding to the metal oxide from a metal salt solution onto the fibers, followed by converting the precipitated metal hydroxide to the metal oxide.

Also provided is an insulating mat for an exhaust gas treatment device thermally stable to at least 900° C., wherein the insulating mat comprises inorganic fibers uniformly coated with a metal oxide comprising at least one of aluminum oxide, titanium oxide zirconium oxide or mixtures thereof; wherein said fibers are uniformly coated with the metal oxide by precipitating metal hydroxide corresponding to the metal oxide on the fibers, followed by converting the precipitated metal hydroxide to the metal oxide. In certain embodiments, the mat comprises a catalytic converter mounting mat. In certain illustrative embodiments, the mat comprises cone insulation.

It has been unexpectedly found that catalytic converter insulating mats comprising inorganic fibers coated with precipitated metal oxides, such as for example aluminum oxide or zirconium oxide, demonstrates an improved thermal stability as compared to prior art insulating mats, permitting such mats to be used for higher temperature applications.

According to the above methods, the inorganic fibers may be soaked in a metal salt solution, optionally in the presence of a polymeric surfactant. Any suitable aluminum, titanium, or zirconium salt which is soluble in water may be used, and the particular metal salt which is the source of the metal ions, such as aluminum, titanium, or zirconium ions, is not critical. Suitable metal salts typically include but are not limited to aluminum nitrate, aluminum chloride, aluminum sulfate, aluminum phosphate, aluminum acetate or aluminum oxalate, titanium nitrate, titanium chloride, titanium sulfate, titanium phosphate, titanium acetate or titanium oxalate, zirconium nitrate, zirconium chloride, zirconium sulfate, zirconium phosphate, zirconium acetate or zirconium oxalate, or mixtures thereof. The concentration of the metal salt is not critical and may be determined by considering the volume of solution and the ability to control the pH during the precipitation step.

In certain illustrative embodiments, the method of improving the thermal stability of an exhaust gas treatment device insulating mat including inorganic fibers comprises contacting the fibers with an about 0.01 to about 10 Molar aqueous solution of at least one water soluble metal salt, which serves as a source of metal ions, such as aluminum ions, titanium ions, or zirconium ions, in the presence of a polymeric surfactant; while the fibers are in contact with the solution, increasing the pH of the solution to at least 5 but less than 7 by addition of a sufficient quantity of a base, such as, for example, ammonium hydroxide, to precipitate a coating of metal hydroxide (i.e., aluminum hydroxide, titanium hydroxide or zirconium hydroxide) from solution onto the fibers; optionally draining the solution to remove liquid from the fibers; optionally drying the fibers by any suitable technique to remove most of the remaining free water from the fibers; and calcining the coated fibers at a temperature of at least 300° C. for about 1 hour, to convert the precipitated metal hydroxide to metal oxide (i.e., aluminum oxide, titanium oxide or zirconium oxide). In other embodiments, the fibers may be contacted with a 0.01 to 1 Molar solution of the water soluble metal salt, optionally a 0.01 to 0.1 Molar solution. The fibers are calcined for a sufficient time to remove any remaining free water not removed during drying and water of hydration, leaving a uniform aluminum oxide, titanium oxide, or zirconium oxide coating on the surface of the fiber. The metal oxide-coated fibers may be used to prepare an automotive exhaust device insulating mat.

Any strong or weak base may be used to increase pH, including, but not limited to, alkali metal hydroxides and water soluble alkali metal oxides, ammonium hydroxide, ammonium carbonate, and hydrogen peroxide. In certain embodiments, the base contains no alkali metals. The pH may be increased by adding controlled amounts of the base in such a manner that the pH is maintained in the desired range of about 5 to less than about 7, optionally with mixing.

Increasing the pH to at least 5 but less than about 7 by introducing a base into contact with the aqueous metal salt solution, such as for example aqueous ammonia alkaline solution, for a sufficient amount of time induces precipitation of metal hydroxide from the ionic solution onto the fiber.

In certain embodiments, rather than adjusting the pH upwardly with a base, the method may comprise including in the solution a compound which will thermally decompose to at least one of free ammonium ion or hydroxyl ion, and heating the solution to decompose the compound. Optionally, said compound is urea.

Alternatively, the pH of the metal salt solution may be adjusted, such as with ammonium hydroxide or another basic compound, so that the adjusted pH is slightly less than that required to precipitate the corresponding metal hydroxide. The solution may then be concentrated by evaporation, thus increasing the pH to at least 5 but less than 7 to precipitate the corresponding metal oxide upon the fiber. Upon exposure to heat, water evaporation may result in a higher pH solution in which the aluminum hydroxide, titanium hydroxide, or zirconium hydroxide precipitates onto the surface of the fiber.

In certain embodiments, the fibers are contacted with the metal salt solution in the presence of a surfactant, such as but not limited to a polymeric surfactant. In certain embodiments, the polymeric surfactant may comprise at least one of ammonium polyacrylic acid, ammonium polymethacrylic acid, polyethylene imine, or mixtures thereof. The polymeric surfactant may be present in a concentration of 0.01 to 10%, optionally 0.1 to 1%.

The precipitated metal hydroxide (such as for example, aluminum hydroxide, titanium hydroxide or zirconium hydroxide) may be dehydrated and converted to the oxide form by optionally draining the solution to remove liquid from the fibers, followed by drying the fibers at a temperature at least sufficient to release adsorbed water for a period of time sufficient to achieve the desired degree of dehydration. In certain embodiments, the fibers are dried at a temperature of from about 60° C. to about 150° C. until substantially dry. This step may also remove volatile reaction by-products such as ammonium salts. The dried fibers may be subsequently calcined as described above, to remove chemically bound water.

In certain embodiments, the fibers are uniformly coated with from about 0.01 to about 5 weight percent of metal oxide, such as aluminum oxide, titanium oxide or zirconium oxide. In certain embodiments, multiple coatings of metal oxide are applied to the fibers. The above procedures are optionally repeated to increase the coating thickness on the fibers. Once a coating of a desired thickness has been achieved, the coated fibers are calcined at a temperature of at least 300° C., optionally for a hold time of approximately 1 hour, to convert the metal hydroxide into metal oxide (i.e., aluminum oxide, titanium oxide or zirconium oxide). The fibers are calcined for a sufficient time to remove both free water and water of hydration, leaving a uniform aluminum oxide, titanium oxide or zirconium oxide coating on the surface of the fibers. This process is an improvement over applying metal oxide coatings in the form of a powder or slurry and then drying as it results in the formation of a much more uniform layer of aluminum oxide, titanium oxide or zirconium oxide on the surface of the fibers.

In certain embodiments, the method comprises applying a coating during the fiberization process, such as disclosed in U.S. Pat. No. 4,312,911, comprising spraying the fiber at an elevated temperature, for example from about 1800° C. down to about 350° C., with an aqueous solution of aluminum ion, titanium ion, or zirconium ion, similar to the solution previously described, during the fiberization step and prior to initial cooling to ambient temperature. The aluminum ion, titanium ion or zirconium ion solution may be sprayed in the form of very fine droplets or mist upon the fiber, i.e., in droplet or particle diameter of from between molecular size to ten times the diameter of the fiber. The droplets may initially be somewhat larger but become smaller as they approach the fiber due to vaporization. The temperature at which the solution is applied is sufficient to immediately vaporize the water and form a uniform aluminum, titanium or zirconium containing compound on the fiber surface, which calcines to form an aluminum oxide, titanium oxide or zirconium oxide coated fiber. The temperature of the fiber struck by the droplets or mist is generally from the melting temperature of the fiber down to about 350° C. In the case of aluminosilicate fibers, when the solution is applied at the time of fiberizing, the temperature may be from about 1500° C. to about 1750° C. In these embodiments, no pH adjustment may be neeeded, as the vaporization of the water when the solution hits the fiber is sufficient to precipitate the corresponding metal hydroxide.

The fibers prepared by the subject precipitation process are uniformly coated with aluminum oxide, titanium oxide and/or zirconium oxide and have improved thermal stability and heat resistance as compared to uncoated fibers or non-uniformly coated fibers of the same composition prepared by applying coatings in the form of a powder or slurry and then drying. A catalytic converter mounting mat made from fibers coated with aluminum oxide, titanium oxide or zirconium oxide by the subject precipitation process have improved thermal stability as compared to prior art mats or articles made from uncoated or non-uniformly coated fibers otherwise having the same composition.

The thermally stable insulating mat is used in an exhaust gas treatment device. A device for treating exhaust gases includes an outer metallic housing, and at least one fragile structure that is mounted within the housing by a mounting mat that is disposed between the inner surface of the housing and the outer surface of the fragile structure. The term “fragile structure” is intended to mean and include structures such as metal or ceramic monoliths or the like which may be fragile or frangible in nature, and would benefit from a mounting mat such as is described herein.

Catalyst structures generally include one or more porous tubular or honeycomb-like structures mounted by a thermally resistant material within a housing. Each structure includes anywhere from about 200 to about 900 or more channels or cells per square inch, depending upon the type of exhaust treating device. A diesel particulate trap differs from a catalyst structure in that each channel or cell within the particulate trap is closed at one end or the other. Particulate is collected from exhaust gases in the porous structure until regenerated by a high temperature burnout process. Non-automotive applications for the insulating or mounting mat may include catalytic converters for chemical industry emission (exhaust) stacks.

One illustrative form of a device for treating exhaust gases is designated by the numeral 10 in FIG. 1. It should be understood that the mounting mat is not intended to be limited to use in the device shown in FIG. 1, and so the shape is shown only as an illustrative embodiment. In fact, the mounting mat could be used to mount or support any fragile structure suitable for treating exhaust gases, such as a diesel catalyst structure, a diesel particulate trap, emission stack catalytic converter, or the like.

Catalytic converter 10 may include a generally tubular housing 12 formed of two pieces of metal, for example, high temperature resistant steel, held together by flange 16. Alternatively, the housing may include a preformed canister into which a mounting mat-wrapped fragile structure is inserted. Housing 12 includes an inlet 14 at one end and an outlet (not shown) at its opposite end. The inlet 14 and outlet are suitably formed at their outer ends whereby they may be secured to conduits in the exhaust system of an internal combustion engine. Device 10 contains a fragile structure, such as a frangible ceramic monolith 18, which is supported and restrained within housing 12 by a mounting mat 20. Monolith 18 includes a plurality of gas pervious passages that extend axially from its inlet end surface at one end to its outlet end surface at its opposite end. Monolith 18 may be constructed of any suitable refractory metal or ceramic material in any known manner and configuration. Monoliths are typically oval or round in cross-sectional configuration, but other shapes are possible.

The monolith is spaced from inner surfaces of the housing by a distance or a gap, which will vary according to the type and design of the device utilized, for example, a catalytic converter, a diesel catalyst structure, or a diesel particulate trap. This gap is filled with a mounting mat 20 to provide resilient support to the ceramic monolith 18. The resilient mounting mat 20 provides both thermal insulation to the external environment and mechanical support to the fragile structure, thereby protecting the fragile structure from mechanical shock across a wide range of exhaust gas treatment device operating temperatures.

In general, the mounting mat includes inorganic fibers, and optionally at least one of intumescent material, organic binder, inorganic binder, or other components. The composition of the mounting mat 20 is sufficient to provide a holding pressure capability to resiliently hold the fragile catalyst support structure 18 within a housing 12 of an exhaust gas treatment device 10 throughout a wide temperature range.

In certain embodiments, suitable inorganic fibers that may be used to prepare the mounting mat include fibers considered non-hazardous due to their high diameter such that they have no respirable fiber fraction.

Without limitation, suitable inorganic fibers that may be used to prepare the insulating mat may comprise at least one of high alumina polycrystalline fibers, mullite fibers, refractory ceramic fibers, such as aluminosilicate fibers, alumina-zirconia-silica fibers, kaolin fibers, alumina-magnesia-silica fibers, silica fibers, biosoluble fibers, or combinations thereof. Biosoluble fibers may comprise alkaline earth silicate fibers such as calcia-magnesia-silica fibers or magnesia-silica fibers, or may comprise calcium aluminate fibers.

According to certain embodiments, the high temperature resistant inorganic fibers that are used to prepare the mounting mat comprise ceramic fibers comprising alumina. Without limitation, suitable ceramic fibers include alumina fibers, mullite fibers, aluminosilicate fibers, alumina-zirconia-silica fibers, kaolin fibers and similar fibers. High alumina polycrystalline fibers may comprise the fiberization product of about 72 to about 100 weight percent alumina and about 0 to about 28 weight percent silica. A suitable aluminosilicate ceramic fiber is commercially available from Unifrax I LLC (Niagara Falls, N.Y.) under the registered trademark FIBERFRAX. The FIBERFRAX® ceramic fibers comprise the fiberization product of a melt comprising about 45 to about 75 weight percent alumina and about 25 to about 55 weight percent silica. The FIBERFRAX® fibers exhibit operating temperatures of up to about 1540° C. and a melting point up to about 1870° C. The FIBERFRAX® fibers can be easily formed into high temperature resistant sheets and papers.

In certain embodiments, refractory ceramic fiber (RCF) such as aluminosilicate fiber may comprise from about 40 weight percent to about 60 weight percent Al₂O₃ and about 60 weight percent to about 40 weight percent SiO₂, and in some embodiments, from about 47 to about 53 weight percent alumina and from about 47 to about 53 weight percent silica. The RCF fibers are a fiberization product that may be blown or spun from a melt of the component materials.

Alumina-zirconia-silica fibers comprise the fiberization product of alumina, silica and zirconia, in certain embodiments in the amounts of from about 29 to about 31 percent by weight alumina, from about 53 to about 55 percent by weight silica, and about 15 to about 17 weight percent zirconia.

Alumina/silica/magnesia glass fiber typically comprises from about 64 weight percent to about 66 weight percent SiO₂, from about 24 weight percent to about 25 weight percent Al₂O₃, and from about 9 weight percent to about 11 weight percent MgO.

In certain embodiments, the mounting mat may comprise melt-formed, amorphous, high-temperature resistant leached glass fibers having a high silica content. By the term “high silica content,” it is meant that the fibers contain more silica than any other compositional ingredient in the fibers. In fact, the silica content of these fibers after leaching are typically greater than any other glass fibers containing silica, including S-glass fibers, except crystalline quartz derived fibers or pure silica fibers. It will be appreciated that in certain embodiments, the mounting mat may be devoid of intumescent materials, sol gel-derived glass silica fibers and/or backing or reinforcing layers.

Generally, the leached glass fibers will have a silica content of at least 67 percent by weight. In certain embodiments, the leached glass fibers contains at least 90 percent by weight, and in certain of these, from about 90 percent by weight to less than 99 percent by weight silica. The average fiber diameter of these leached glass fibers may be greater than at least about 3.5 microns, and often greater than at least about 5 microns. On average, the glass fibers typically have a diameter of about 9 microns, up to about 14 microns. Thus, these leached glass fibers are non-respirable.

Examples of leached glass fibers high in silica content and suitable for use in the production of a mounting mat for a catalytic converter or other known exhaust gas-treatment device include those leached glass fibers available from BelChem Fiber Materials GmbH, Germany, under the trademark BELCOTEX and from Hitco Carbon Composites, Inc. of Gardena Calif., under the registered trademark REFRASIL®, and from Polotsk-Steklovolokno, Republic of Belarus, under the designation PS-23®.

The BELCOTEX fibers are standard type, staple fiber pre-yarns. These fibers have an average fineness of about 550 tex and are generally made from silicic acid modified by alumina. The BELCOTEX fibers are amorphous and generally contain about 94.5 silica, about 4.5 percent alumina, less than 0.5 percent sodium oxide, and less than 0.5 percent of other components. These fibers have an average fiber diameter of about 9 microns and a melting point in the range of 1500° to 1550° C. These fibers are heat resistant to temperatures of up to 1100° C., and are typically shot free and binder free.

The REFRASIL® fibers, like the BELCOTEX fibers, are amorphous leached glass fibers high in silica content for providing thermal insulation for applications in the 1000° to 1100° C. temperature range. These fibers are between about 6 and about 13 microns in diameter, and have a melting point of about 1700° C. The fibers, after leaching, typically have a silica content of about 95 percent by weight. Alumina may be present in an amount of about 4 percent by weight with other components being present in an amount of 1 percent or less.

The PS-23® fibers from Polotsk-Steklovolokno are amorphous glass fibers high in silica content and are suitable for thermal insulation for applications requiring resistance to at least about 1000° C. These fibers have a fiber length in the range of about 5 to about 20 mm and a fiber diameter of about 9 microns. These fibers, like the REFRASIL® fibers, have a melting point of about 1700° C.

The term “biosoluble” inorganic fibers refer to inorganic fibers that are soluble or otherwise decomposable in a physiological medium or in a simulated physiological medium, such as simulated lung fluid. The solubility of the fibers may be evaluated by measuring the solubility of the fibers in a simulated physiological medium over time. Biosolubility can also be estimated by observing the effects of direct implantation of the fibers in test animals or by the examination of animals or humans that have been exposed to fibers, i.e. biopersistence.

A method for measuring the biosolubility (i.e. the non-durability) of the fibers in physiological media is disclosed U.S. Pat. No. 5,874,375 assigned to Unifrax, which is incorporated herein by reference. Other methods are suitable for evaluating the biosolubility of inorganic fibers. According to certain embodiments, the biosoluble fibers exhibit a solubility of at least 30 ng/cm²-hr when exposed as a 0.1 g sample to a 0.3 ml/min flow of simulated lung fluid at 37° C. According to other embodiments, the biosoluble inorganic fibers may exhibit a solubility of at least 50 ng/cm²-hr, or at least 100 ng/cm²-hr, or at least 1000 ng/cm²-hr when exposed as a 0.1 g sample to a 0.3 ml/min flow of simulated lung fluid at 37° C.

Another approach to estimating the biosolubility of fibers is based on the composition of the fibers. For example, Germany classifies respirable inorganic oxide fibers based on a compositional index (KI value). The KI value is calculated by a summation of the weight percentages of alkaline and alkaline-earth oxides and subtraction of two times the weight percent of aluminum oxide in inorganic oxide fibers. Inorganic fibers that are biosoluble typically have a KI value of about 40 or greater.

Without limitation, suitable examples of biosoluble inorganic fibers that can be heat treated and used to prepare a mounting mat for an exhaust gas treatment device include those biosoluble inorganic fibers disclosed in U.S. Pat. Nos. 6,953,757; 6,030,910; 6,025,288; 5,874,375; 5,585,312; 5,332,699; 5,714,421; 7,259,118; 7,153,796; 6,861,381; 5,955,389; 5,928,075; 5,821,183; and 5,811,360; each of which are incorporated herein by reference.

According to certain embodiments, the biosoluble alkaline earth silicate fibers may comprise the fiberization product of a mixture of oxides of magnesium and silica. These fibers are commonly referred to as magnesium-silicate fibers. The magnesium-silicate fibers generally comprise the fiberization product of about 60 to about 90 weight percent silica, from greater than 0 to about 35 weight percent magnesia and 5 weight percent or less impurities. According to certain embodiments, the heat treated alkaline earth silicate fibers comprise the fiberization product of about 65 to about 86 weight percent silica, about 14 to about 35 weight percent magnesia, 0 to about 7 weight percent zirconia and 5 weight percent or less impurities. According to other embodiments, the heat treated alkaline earth silicate fibers comprise the fiberization product of about 70 to about 86 weight percent silica, about 14 to about 30 weight percent magnesia, and 5 weight percent or less impurities. More information on magnesia-silica fibers can be found in U.S. Pat. No. 5,874,375, which is hereby incorporated by reference.

A suitable magnesium-silicate fiber is commercially available from Unifrax I LLC (Niagara Falls, N.Y.) under the registered trademark ISOFRAX. Commercially available ISOFRAX fibers generally comprise the fiberization product of about 70 to about 80 weight percent silica, about 18 to about 27 weight percent magnesia and 4 weight percent or less impurities.

According to certain embodiments, the biosoluble alkaline earth silicate fibers may comprise the fiberization product of a mixture of oxides of calcium, magnesium and silica. These fibers are commonly referred to as calcia-magnesia-silicate fibers. According to certain embodiments, the calcia-magnesia-silicate fibers comprise the fiberization product of about 45 to about 90 weight percent silica, from greater than 0 to about 45 weight percent calcia, from greater than 0 to about 35 weight percent magnesia, and 10 weight percent or less impurities. Typically, biosoluble calcia-magnesia-silica fibers comprise about 15% to about 35% CaO, about 2.5% to about 20% MgO, and about 60 to about 70% SiO₂.

Useful calcia-magnesia-silicate fibers are commercially available from Unifrax I LLC (Niagara Falls, N.Y.) under the registered trademark INSULFRAX. INSULFRAX fibers generally comprise the fiberization product of about 61 to about 67 weight percent silica, from about 27 to about 33 weight percent calcia, and from about 2 to about 7 weight percent magnesia. Other suitable calcia-magnesia-silicate fibers are commercially available from Thermal Ceramics (Augusta, Ga.) under the trade designations SUPERWOOL 607, SUPERWOOL 607 MAX and SUPERWOOL HT. SUPERWOOL 607 fibers comprise about 60 to about 70 weight percent silica, from about 25 to about 35 weight percent calcia, and from about 4 to about 7 weight percent magnesia, and trace amounts of alumina. SUPERWOOL 607 MAX fibers comprise about 60 to about 70 weight percent silica, from about 16 to about 22 weight percent calcia, and from about 12 to about 19 weight percent magnesia, and trace amounts of alumina. SUPERWOOL HT fiber comprise about 74 weight percent silica, about 24 weight percent calcia and trace amounts of magnesia, alumina and iron oxide.

According to certain embodiments, at least about 90 weight percent of the calcium-aluminate fiber may comprise the fiberization product of about 20 to about 50 weight percent calcia and about 50 to about 80 weight percent alumina. In other embodiments, at least 90 weight percent of the calcium aluminate fiber comprises the fiberization product of greater than 50 weight percent calcia and greater than 0 to less than 50 weight percent alumina. The fibers may contain about 10 weight percent or less silica. More information on calcium aluminate biosoluble fibers can be found in U.S. Pat. No. 5,346,868 and International Patent Publication WO 2008/005008, which are incorporated herein by reference.

The biosoluble fibers are typically amorphous inorganic or glass fibers that may be melt-formed, are fibers of high chemical purity (greater than about 98%) and may have an average diameter in the range of about 1 to about 10 μm, and in certain embodiments, in the range of about 2 to 4 μm. While not specifically required, the fibers may be beneficiated, as is well known in the art.

The intumescent material that may optionally be incorporated into the mounting mat may include, without limitation, unexpanded vermiculite, ion-exchanged vermiculite, heat treated vermiculite, expandable graphite, hydrobiotite, water-swelling tetrasilicic flourine mica, alkaline metal silicates, or mixtures thereof. The intumescent material may be present in the mounting mat in the amount of about 10% to about 60% by weight of the final mat. The mounting mat may include a mixture of more than one type of intumescent material. The intumescent material may comprise a mixture of unexpanded vermiculite and expandable graphite in a relative amount of about 9:1 to about 1:2 vermiculite:graphite, as described in U.S. Pat. No. 5,384,188, incorporated herein by reference.

In some embodiments, the mounting mat may comprise a substantially non-expanding multilayer sheet of high temperature resistant inorganic fibers and optionally a binder. By “substantially non-expanding” is meant that the sheet does not readily expand upon the application of heat as would be expected with intumescent paper. Of course, some expansion of the sheet does occur based upon its thermal coefficient of expansion. The amount of expansion, however, is insubstantial as compared to the expansion which occurs based upon intumescent properties. It will be appreciated that this type of mounting mat may be substantially devoid of intumescent materials.

The mounting mat comprise one or more organic binders. The organic binders may be provided as a solid such as a binder powder, a liquid, a solution, a dispersion, a latex, an emulsion, or similar form. The organic binder may comprise a thermoplastic or thermoset binder, which after cure is a flexible material that can be burned out of an installed mounting mat. Examples of suitable organic binders include, but are not limited to, acrylic latex, (meth)acrylic latex, copolymers of styrene and butadiene, vinylpyridine, acrylonitrile, copolymers of acrylonitrile and styrene, vinyl chloride, polyurethane, copolymers of vinyl acetate and ethylene, polyamides, and the like. Other resins include low temperature, flexible thermosetting resins such as unsaturated polyesters, epoxy resins and polyvinyl esters.

The organic binder may be included in the mounting mat in an amount of greater than 0 to about 20 weight percent, in certain embodiments from about 0.5 to about 15 weight percent, in other embodiments from about 1 to about 10 weight percent and in some embodiments from about 2 to about 8 weight percent, based on the total weight of the mounting mat.

The mounting mat may include polymeric binder fibers instead of, or in addition to, a resinous or liquid binder. These polymeric binder fibers may be used in amounts ranging from greater than 0 to about 20 percent by weight, in certain embodiments from about 1 to about 15 weight percent, and in other embodiments from about 2 to about 10 weight percent, based upon the total weight of the mounting mat, to aid in binding the heat resistant inorganic fibers together. Suitable examples of binder fibers include polyvinyl alcohol fibers, polyvinyl acetate fibers, polyolefin fibers such as polyethylene and polypropylene, acrylic fibers, polyester fibers, ethyl vinyl acetate fibers, nylon fibers and combinations thereof.

Typically, the organic binder is a sacrificial binder employed to initially bond the fibers together. By “sacrificial,” it is meant that the organic binder will eventually be burned out of the mounting mat, leaving the inorganic fibers, and optionally intumescent material as components of the mounting mat for supporting the fragile structure within the metallic housing.

Solvents for the binders can include water, or a suitable organic solvent, such as acetone, for the binder utilized. Solution strength of the binder in the solvent (if used) can be determined by conventional methods based on the binder loading desired and the workability of the binder system (viscosity, solids content, etc.).

In certain embodiments, the multilayer mounting mat may further comprise at least one of colloidal silica, colloidal alumina, colloidal zirconia, or combinations thereof. The colloidal inorganic oxide may be added to the mounting mat in an amount from about 0.1 weight percent to about 10 weight percent, based on the total weight of the mounting mat.

The mounting mat may be produced in any way known in the art for forming sheet-like materials. For example, conventional paper-making processes, either hand laid or machine laid, may be used to prepare the intumescent sheet material. A handsheet mold, a Fourdrinier paper machine, or a rotoformer paper machine can be employed to make the intumescent sheet material.

For example, using a papermaking process, the inorganic fibers, organic binder, and optionally intumescent material, may be mixed together to form a mixture or slurry. The fibrous components may be mixed at about a 0.25% to 5% consistency or solids content (0.25-5 parts solids to 99.75-95 parts water). The slurry of components may be diluted with water to enhance formation, and may be flocculated by adding a flocculating agent and drainage retention aid chemicals and optionally other additives to the slurry. The flocculated mixture or slurry is placed onto a papermaking machine to be formed into a ply or sheet of fiber containing paper. The sheet is dried by air drying or oven drying. For a more detailed description of standard papermaking techniques employed, see U.S. Pat. No. 3,458,329, the disclosure of which is incorporated herein by reference.

Alternatively, the plies or sheets may be formed by vacuum casting the slurry. According to this method, the slurry of components is wet laid onto a pervious web. A vacuum is applied to the web to extract the majority of the moisture from the slurry, thereby forming a wet sheet. The wet plies or sheets are then dried, typically in an oven. The sheet may be passed through a set of rollers to compress the sheet prior to drying.

In other embodiments, the fibers may be processed into a mounting mat by conventional means such as dry air laying. The mat at this stage has very little structural integrity and is very thick relative to conventional catalytic converter and diesel trap mounting mats. The resultant mat can therefore be dry needled, as is commonly known in the art, to densify the mat and increase its strength.

Where the dry air layering technique is used, the mat may be alternatively processed by the addition of a binder to the mat by impregnation to form a discontinuous fiber composite. In this technique, the binder is added after formation of the mat, rather than forming the mat prepreg as noted hereinabove with respect to the conventional papermaking technique. This method of preparing the mat aids in maintaining fiber length by reducing breakage.

Methods of impregnation of the mat with the binder include complete submersion of the mat in a liquid binder system, or alternatively spraying the mat. In a continuous procedure, a fiber mat which can be transported in roll form, is unwound and moved, such as on a conveyer or scrim, past spray nozzles which apply the binder to the mat. Alternatively, the mat can be gravity-fed past the spray nozzles. The mat/binder prepreg is then passed between press rolls, which remove excess liquid and densify the prepreg to approximately its desired thickness. The densified prepreg may then be passed through an oven to remove any remaining solvent and if necessary to partially cure the binder to form a composite. The drying and curing temperature is primarily dependent upon the binder and solvent (if any) used. The composite can then either be cut or rolled for storage or transportation.

The mounting mat can also be made in a batch mode, by immersing a section of the mat in a liquid binder, removing the prepreg and pressing to remove excess liquid, thereafter drying to form the composite and storing or cutting to size.

It is noted that mounting mats may be too low in density for easy use in certain applications. Therefore, they may undergo further densification by any manner known in the art to provide a higher density. One such manner of densification is to needle punch the fibers so as to intertwine and entangle them. Additionally or alternatively, hydro-entangling methods may be used. Another alternative is to press the fibers into a mat form by rolling them through press rollers. Any of these methods of densification of the mats or a combination of these methods can be readily used to obtain a mounting mat of the correct and desired form.

Regardless of which of the above-described techniques are employed, the composite can be cut, such as by die stamping, to form mounting mats of exact shapes and sizes with reproducible tolerances. The mounting mat 20 exhibits suitable handling properties upon densification as by needling or the like, meaning it can be easily handled and is not so brittle as to crumble in one's hand like many other fiber blankets or mats. It can be easily and flexibly fitted or wrapped around the fragile structure 18 or like fragile structure without cracking, and then disposed within the catalytic converter housing 12. Generally, the mounting mat-wrapped fragile structure can be inserted into a housing or the housing can be built or otherwise fabricated around the mounting mat-wrapped fragile structure.

In operation, the exhaust gas treatment device experiences a significant change in temperature. Due to the differences in their thermal expansion coefficients, the housing may expand more than the support structure 18, such that the gap between these elements will increase slightly. In a typical case, the gap may expand and contract on the order of about 0.25 to about 0.5 mm during thermal cycling of the converter. The thickness and mounting density of the mounting mat is selected such that a specified minimum holding pressure is maintained under all conditions to prevent the fragile structure from vibrating loose. The mounting pressure exerted by the mounting mat 20 under these conditions permits accommodation of the thermal characteristics of the assembly without compromising the physical integrity of the constituent elements.

### EXAMPLES

The following examples are set forth merely to further illustrate the mounting mat for an exhaust gas treatment device and the improved thermal stability of inorganic fibers coated with aluminum oxide, titanium oxide or zirconium oxide via chemical precipitation. The illustrative examples should not be construed as limiting the mounting mat, exhaust gas treatment device incorporating the mounting mat, or the methods of making the mounting mat or the exhaust gas treatment device in any manner.

### Example 1

### Preparation of Aluminum Oxide Coated Leached Silica Fibers

The following is an example demonstrating the method of preparing leached silica fibers coated with precipitated aluminum oxide. Five liters of aqueous 0.1M aluminum nitrate, Al(NO₃)₃ solution was prepared. To this solution was added 1 ml of Darvan® 821A (ammonium polyacrylic acid) surfactant, and 200 g of silica fiber (9 μm diameter Polotsk-Steklovolokno PS-23 fibers, 12 mm long), and the components mixed for approximately 30 minutes. A sufficient quantity of ammonium hydroxide was then added to the solution with mixing to increase the pH to at least 5 but less than 7, causing the precipitation of aluminum hydroxide onto the fibers. The solution was drained, leaving only the aluminum hydroxide coated fibers. The fibers were dried at approximately 110° C. until dry. The dry fibers were then calcined at a temperature of at least 800° C. for a hold time of 1 hour. A catalytic converter insulating mat was made from these fibers by a typical paper making process, in which handsheets were prepared in a sheet mold.

### Example 2

The relative expansion of insulating mats made from coated fibers prepared as set forth in Example 1 was evaluated in a single cycle expansion test. Table 1 reports the stability of the fibers as a function of creep onset temperature (° C.) of subject catalytic converter mounting mats made from leached silica fibers coated with precipitated aluminum oxide, titanium oxide or zirconium oxide, and as compared to a mounting mat made from uncoated leached silica fibers. Creep onset temperature is the temperature at which the relative expansion has decreased 1% from the value at 600° C.

By the term “cycle” it is meant that an opening equal to the gap between the monolith (i.e., fragile structure) and housing is opened and closed over a specific distance and at a predetermined rate. In order to simulate realistic conditions, the expansion of the gap between a housing and a fragile structure of a given diameter may be determined by calculating the coefficient of thermal expansion of a conventional housing at a temperature of, for example, about 900° C.

As reported in Table 1 below, four mounting mats were tested, as follows:

1. Alumina coated leached silica fiber mat comprising leached silica fibers (9 μm diameter Polotsk-Steklovolokno PS-23® fibers) coated with precipitated aluminum oxide according to the process described in Example 1. About 93.25 wt. % leached silica fiber and about 7% binder fiber was mixed in water, and was formed into the mat in a sheet mold. The sheets were dried at 110° C., and hot pressed to a final density of approximately 0.17 g/cm³.

2. Titania coated leached silica fiber mat comprising leached silica fibers (9 μm diameter Polotsk-Steklovolokno PS-23® fibers) coated with precipitated titanium oxide according to the process described above.

3. Zirconia coated leached silica fiber mat comprising leached silica fibers (9 μm diameter Polotsk-Steklovolokno PS-23® fibers) coated with precipitated zirconium oxide according to the process described above.

4. Uncoated leached silica fiber mat comprising uncoated, leached silica fibers (9 μm diameter Polotsk-Steklovolokno PS-23® fibers) and binder fibers.

In each test run, a mat sample of area of 1 in² was positioned and held between two horizontal quartz rams. The mounting mats were compressed by applying a constant load of about 50 psi to the mats. The mats were then allowed to relax for about 5 minutes at room temperature. The relative thickness of each mat was then measured mechanically as a function of time/temperature as the mats were heated from about 50° C. to about 1000° C. at a rate of 15° C./minute. The results of the single cycle expansion testing are reported in Table 1, in which creep onset temperature is defined as the temperature at which the relative expansion has decreased 1% from the value at 600° C.

Table 1 lists the elevated temperature for the four sample mats 2.1 through 2.4, at which the relative thickness change decreased 1% from the value at 600° C. The results reported in Table 1 indicate that the precipitated alumina coated fiber containing mat demonstrated improved thermal stability as indicated by a higher creep onset temperature, compared to the uncoated mat. This improved stability allows the mounting mat to be used for higher temperature applications and improves the product reliability.

### Example 3

Precipitated alumina coated fiber containing mounting mats were prepared comprising Fiberfrax® aluminosilicate fibers available from Unifrax I LLC (Niagara Falls, N.Y.) coated with precipitated aluminum oxide according to Example 1, using two different polymeric surfactants in the corresponding metal salt solutions. About 93.25 wt. % aluminosilicate fiber and about 7% binder fiber was mixed in water, and was formed into the mat in a sheet mold. The sheets were dried at 110° C., and hot pressed to a final density of approximately 0.17 g/cm³.

The relative expansion of the coated mounting mats was evaluated in a single cycle expansion test and compared to a mounting mat comprising uncoated aluminosilicate fibers and binder fiber. Table 1 indicates the creep onset temperature at which the relative expansion has decreased 1% from the value at 600° C. for samples 3.1 to 3.3. The results demonstrate the improvement in thermal stability of mounting mats made with aluminosilicate fibers coated with precipitated aluminum oxide as compared to a mat made with uncoated aluminosilicate fiber, as indicated by the higher creep onset temperatures.

### Example 4

A precipitated alumina coated fiber containing mounting mat was prepared comprising leached silica fibers (9 μm diameter PS-23® fibers available from Polotsk-Steklovolokno, coated with precipitated aluminum oxide in the amount of 1 weight % according to the procedure of Example 1. About 93.25 wt. % leached silica fiber and about 7% binder fiber was mixed in water, and was formed into the mat in a sheet mold. The sheets were dried at 110° C., and hot pressed to a final density of approximately 0.17 g/cm³.

The relative expansion of the coated mounting mat was evaluated in a single cycle expansion test and compared to a control mounting mat comprising leached silica fibers (9 μm diameter PS-23® fibers) and binder fibers prepared in a similar manner, but coated with 20 weight % colloidal aluminum oxide. The mat was formed in a sheet mold, dried and then heat pressed to the final density.

The results demonstrated an improvement in the thermal stability of the mat coated with precipitated aluminum oxide as compared to the mat coated with colloidal aluminum oxide. The precipitated metal oxide coating was more effective in extending the thermal stability of the inorganic fiber than was a coating of pre-formed metal oxide particles.

### Example 5

The relative expansion of insulating mats made from coated fibers prepared as set forth in Example 1 using various metal salts and polymeric surfactants, was evaluated as set forth above. Table 1 reports the stability of the fibers as a function of creep onset temperature (° C.) of subject catalytic converter mounting mats made from BELCOTEX leached silica fibers available from BelChem Fiber Materials GmbH, Germany, coated with precipitated aluminum oxide, titanium oxide or zirconium oxide, as compared to mounting mats made from uncoated BELCOTEX leached silica fibers.

The results reported in Table 1 indicate that the precipitated metal oxide coated fiber containing mats (Samples 5.2-5.5 and 5.7-5.8) demonstrated generally improved thermal stability as indicated by a higher creep onset temperature, compared to the uncoated fiber containing mats (Samples 5.1 and 5.6).

### Example 6

The relative expansion of insulating mats made from coated fibers prepared as set forth in Example 1 was evaluated as set forth above. Table 1 reports the stability of the fibers as a function of creep onset temperature (° C.) of subject catalytic converter mounting mats made from magnesium-silicate fiber, commercially available from Unifrax I LLC (Niagara Falls, N.Y.) under the registered trademark ISOFRAX, coated with precipitated aluminum oxide, or titanium oxide (Samples 6.2-6.3), as compared to a mounting mat made from uncoated ISOFRAX fibers (Sample 6.1).

The results reported in Table 1 indicate that the precipitated metal oxide coated fiber containing mats (Samples 6.2 and 6.3) demonstrated improved thermal stability as indicated by a higher creep onset temperature, compared to the uncoated fiber containing mat (Sample 6.1).

TABLE I

| | Solution | Coating | Surfactant | | Calcine | Creep Onset |
|---|---|---|---|---|---|---|
| Examples | Concentration | Type | Concentration | Surfactant | Temp. | Temperature |
| (Sample No.) | (M) | (Oxide) | (%) | Type | (° C.) | (° C.) |
| 2.1 | 0.1 | Al | 0.1 | Ammonium Polyacrylate | 1000 | 697 |
| 2.2 | 0.1 | Ti | 0.1 | Ammonium Polyacrylate | 1000 | 633 |
| 2.3 | 0.1 | Zr | 0.1 | Ammonium Polyacrylate | 1000 | 617 |
| 2.4 | N/A | N/A | N/A | N/A | 1000 | 644 |
| 3.1 | 0.1 | Al | 0.1 | Ammonium Polyacrylate | 1000 | 940 |
| 3.2 | 0.1 | Al | 0.1 | Ammonium Polymethacrylate | 1000 | 931 |
| 3.3 | 0.1 | N/A | N/A | N/A | 1000 | 881 |
| 5.1 | N/A | N/A | N/A | N/A | 850 | 826 |
| 5.2 | 0.01 | Al | 0.1 | Ammonium Polyacrylate | 850 | 837 |
| 5.3 | 0.10 | Al | 1 | Ammonium Polyacrylate | 850 | 861 |
| 5.4 | 0.01 | Ti | 0.1 | Ammonium Polyacrylate | 850 | 836 |
| 5.5 | 0.01 | Zr | 0.1 | Ammonium Polyacrylate | 850 | 836 |
| 5.6 | N/A | N/A | N/A | N/A | 850 | 828 |
| 5.7 | 0.01 | Al | 0.1 | Polyethylene Imine | 850 | 841 |
| 5.8 | 0.01 | Ti | 0.1 | Polyethylene Imine | 850 | 790 |
| 6.1 | N/A | N/A | N/A | N/A | 850 | 742 |
| 6.2 | 0.01 | Al | 0.1 | Ammonium Polyacrylate | 850 | 750 |
| 6.3 | 0.01 | Ti | 0.1 | Ammonium Polyacrylate | 850 | 812 |

The subject mats comprising fibers coated with precipitated metal oxide are advantageous to the catalytic converter and diesel particulate trap industry. The insulating mats can be die cut and are operable as resilient supports in a thin profile, providing ease of handling, and in a flexible form, so as to be able to provide a total wrap of the catalyst support structure, if desired, without cracking. Alternatively, the insulating mat may be integrally wrapped about the entire circumference or perimeter of at least a portion of the catalyst support structure. The insulating mat may also be partially wrapped and include an end-seal as currently used in some conventional converter devices, if desired, to prevent gas by-pass.

The insulating mats described above are also useful in a variety of applications such as conventional automotive catalytic converters for, among others, motorcycles and other small engine machines, and automotive preconverters, as well as high temperature spacers, gaskets, and even future generation automotive underbody catalytic converter systems. Generally, they can be used in any application requiring a mat or gasket to exert holding pressure at room temperature and, more importantly, to provide the ability to maintain the holding pressure at elevated temperature, including during thermal cycling.

The insulating mat material may be used as end cone insulation in an exhaust gas treatment device. According to certain embodiments, an end cone for an exhaust gas treatment device is provided. The end cone generally comprises an outer metallic cone, an inner metallic cone and end cone insulation that is disposed within the gap or space between the outer and inner metallic end cones.

According to other embodiments, the end cone may comprise an outer metallic cone and at least one layer of cone insulation that is positioned adjacent to the inner surface of the outer metallic cone. According to these embodiments, the end cone assembly is not provided with an inner metallic cone. Rather, the cone insulation is rigidized in some manner to provide a self-supporting cone structure that is resistant to the high temperature gases flowing through the device.

An exhaust gas treatment device including at least one end cone is provided. The exhaust gas treatment device comprises a housing, a fragile structure positioned within the housing, an inlet and an outlet end cone assemblies for attaching exhaust pipes to the housing, each end cone assembly comprising an inner end cone housing and an outer end cone housing; and end cone insulation comprising heat treated biosoluble fibers and optionally intumescent material positioned between the inner and outer cone housings.

The insulating mats described above can also be used in catalytic converters employed in the chemical industry which are located within exhaust or emission stacks, including those which contain fragile honeycomb type structures that need to be protectively mounted.

The insulating mat material may be used as passive fire protection or as a fire stop material. The insulating mats may also be used to wrap heat generating elements within fuel cells.

While the insulating mats for an exhaust gas treatment device have been described in connection with various illustrative embodiments, it is to be understood that other similar embodiments may be used or modifications and additions may be made to the described embodiments for performing the same function disclosed herein without deviating therefrom. The embodiments described above are not necessarily in the alternative, as various embodiments may be combined to provide the desired characteristics. Therefore, the insulating mats for an exhaust gas treatment device should not be limited to any single embodiment, but rather construed in breadth and scope in accordance with the recitation of the appended claims.

We claim:

1. A method of increasing the thermal stability of inorganic fibers for use in an exhaust gas treatment device insulating mat including the inorganic fibers, comprising uniformly coating the fibers with a metal oxide comprising at least one of aluminum oxide, titanium oxide, zirconium oxide or mixtures thereof by a chemical precipitation process comprising:
(a) contacting the fibers with an aqueous solution containing at least one water soluble corresponding metal salt of the metal oxide, optionally at a concentration of about 0.01 to about 10 Molar;
(b) while the fibers are in contact with the solution, precipitating a coating of a corresponding metal hydroxide from solution Onto the fibers, optionally by increasing the solution pH to at least about 5 but less than about 7; and,
(c) calcining the coated fibers at a temperature of at least about 300° C. for a time sufficient to convert the precipitated metal hydroxide to the metal oxide.

2. The method of claim 1 wherein the inorganic fibers comprise at least one of high alumina polycrystalline fibers, mullite fibers, refractory ceramic fibers, aluminosilicate fibers, alumina-zirconia-silica fibers, alumina-magnesia-silica fibers, kaolin fibers, silica fibers, biosoluble fibers, or combinations thereof.

3. The method of claim 2, wherein the high alumina polycrystalline fibers comprise the fiberization product of about 72 to about 100 weight percent alumina and about 0 to about 28 weight percent silica.

4. The method of claim 2, wherein the ceramic fibers comprise aluminosilicate fibers comprising the fiberization product of about 45 to about 72 weight percent alumina and about 28 to about 55 weight percent silica.

5. The method of claim 2, wherein the biosoluble fibers comprise magnesia-silica fibers comprising the fiberization product of about 65 to about 86 weight percent silica, from about 14 to about 35 weight percent magnesia and about 5 weight percent of less impurities.

6. The method of claim 2, wherein the biosoluble fibers comprise calcia-magnesia-silica fibers comprising the fiberization product of about 45 to about 90 weight percent silica, greater than 0 to about 45 weight percent calcia, and greater than 0 to about 35 weight percent magnesia.

7. The method of claim 2, wherein the biosoluble fibers comprise calcium aluminate fibers.

8. The method of claim 1, wherein the metal salt comprises at least one of aluminum nitrate, aluminum chloride, aluminum sulfate, aluminum phosphate, aluminum acetate, aluminum oxalate, titanium nitrate, titanium chloride, titanium sulfate, titanium phosphate, titanium acetate, titanium oxalate, zirconium nitrate, zirconium chloride, zirconium sulfate, zirconium phosphate, zirconium acetate, zirconium oxalate, or mixtures thereof.

9. The method of claim 1, wherein the fibers are contacted with the aqueous solution in the presence of a surfactant.

10. The method of claim 9, wherein the surfactant comprises at least one of ammonium polyacrylic acid, ammonium polymethacrylic acid, polyethylene imine, or mixtures thereof.

11. The method of claim 1, wherein said pH is increased by adding to the solution a strong or weak base, optionally comprising at least one of alkali metal hydroxide, water soluble alkali metal oxide, ammonium hydroxide, ammonium carbonate, or hydrogen peroxide; or by including in the solution a compound which will thermally decompose to at least one of free ammonium ion or hydroxyl ion, and heating the solution to decompose the compound, optionally wherein said compound is urea.

12. The method of claim 1, wherein after said precipitating, further including draining the solution to remove liquid from the fibers.

13. The method of claim 12, comprising after said draining, drying the fibers at a temperature of from about 90° C. to about 150° C. until substantially dry.

14. The method of claim 1, wherein the fibers are calcined at a temperature of from about 300° C. to about 1000° C.

15. The method of claim 1, including applying multiple coatings of the metal oxide to the fibers.

16. An insulating mat for an exhaust gas treatment device thermally stable to at least 900° C., wherein the insulating mat comprises inorganic fibers uniformly coated with a metal oxide comprising at least one of aluminum oxide, titanium oxide, zirconium oxide, or mixtures thereof; wherein said fibers are uniformly coated with the metal oxide by precipitating metal hydroxide corresponding to the metal oxide on the fibers, followed by converting the precipitated metal hydroxide to the metal oxide.

17. The mat of claim 16, wherein said precipitating comprises contacting the fibers with an aqueous solution containing at least one water soluble corresponding metal salt of the metal oxide, optionally at a concentration of about 0.01 to about 10 Molar; and, while the fibers are in contact with the solution, increasing the solution pH to at least about 5 but less than about 7.

18. The mat of claim 16, wherein said converting comprises calcining the coated fibers at a temperature of at least about 300° C. for a time sufficient to convert the precipitated metal hydroxide to the metal oxide.

19. The mat of claim 16, wherein the inorganic fibers comprise at least one of high alumina polycrystalline fibers, mullite fibers, refractory ceramic fibers, aluminosilicate fibers, alumina-zirconia-silica fibers, alumina-magnesia-silica fibers, kaolin fibers, silica fibers, biosoluble fibers, or combinations thereof.

20. The mat of claim 19, wherein the high alumina polycrystalline fibers comprise the fiberization product of about 72 to about 100 weight percent alumina and about 0 to about 28 weight percent silica.

21. The mat of claim 19, wherein the ceramic fibers comprise aluminosilicate fibers comprising the fiberization product of about 45 to about 72 weight percent alumina and about 28 to about 55 weight percent silica.

22. The mat of claim 19, wherein the biosoluble fibers comprise magnesia-silica fibers comprising the fiberization product of about 65 to about 86 weight percent silica, from about 14 to about 35 weight percent magnesia and about 5 weight percent of less impurities.

23. The mat of claim 19, wherein the biosoluble fibers comprise calcia-magnesia-silica fibers comprising the fiberization product of about 45 to about 90 weight percent silica, greater than 0 to about 45 weight percent calcia, and greater than 0 to about 35 weight percent magnesia.

24. The mat of claim 19, wherein the biosoluble fibers comprise calcium aluminate fibers.

25. The mat of claim 16, comprising a catalytic converter mounting mat.

26. The mat of claim 16, comprising cone insulation.

27. A method of improving the thermal stability of an exhaust gas treatment device insulating mat containing inorganic fibers, comprising incorporating into the mat said inorganic fibers, uniformly coated with a metal oxide comprising at least one of aluminum oxide, titanium oxide, zirconium oxide, or mixtures thereof by a chemical precipitation process, comprising precipitating metal hydroxide corresponding to the metal oxide from a metal salt solution onto the fibers, followed by converting the precipitated metal hydroxide to the metal oxide.
